(19) United States
(12) Patent Application Publication
(10) Pub. No.: US 2004/0019584 A1
(43) Pub. Date: Jan. 29, 2004

(54) Community directory

(76) Inventors: Daniel Rex Greening, Sausalito, CA (US); John B. Hodges JR., Moss Beach, CA (US)

Correspondence Address: Daniel Rex Greening, 67 Crescent Ave, Sausalito, CA, 94965-2315, US

(21) Appl. No.: 10/393,076

(22) Filed: Mar. 18, 2003

Related U.S. Application Data
(60) Provisional application No. 60/365,493, filed on Mar. 18, 2002.

(51) Int. Cl. G06F 7/00

(52) U.S. Cl. 707/1

(57) ABSTRACT

Community members possess information relating to the community, and share that information with other community members to further the goals of the whole community. Some communities—such as geographic positioning system users, music lovers and mail-order businesses—indirectly hire a professional staff to gather information by purchasing professionally assembled directories. However, professionally assembled directories introduce costs for aggregating what community members may already know, and the professional staff's information may not be as accurate as information held by the members. However, simply assembling data from community members may introduce problems of data quality—some community members may be careful, some may be sloppy and some may be malicious.

The present invention relates to a system for building a directory of information from members of a community, by distinguishing between members who have historically provided good data and members who have not. A member's data submissions are associated with the member. Corrections to a member's data may result in the system being less likely to accept submissions from that member. More submissions and more usage of the member's data may result in the system being more likely to accept submissions from that member. The system could compensate members with few corrections, many submissions and many references.

The intent is to create a community-built directory that rivals or exceeds the quality and completeness of professionally assembled directories. Further, a professional organization could incorporate the invention to improve the quality of results from its staff.

The present invention considers an embodiment relating to “location directories,” which contains items characterized by a geographic location, such as businesses, homes, wireless internet hotspots, events, etc.

Aspects of the invention include supporting interfaces, such as automatic methods to prompt users to enter location information, and methods for a user outlining a region (such as a building) on a satellite image or map.

### CROSS-REFERENCE TO RELATED APPLICATIONS

U.S. Provisional Patent Application No. 60/365,493, “Community-Contributed Location Directory,” filed Mar. 18, 2002, Jack Hodges and Dan Greening.

### FEDERALLY SPONSORED RESEARCH

Not applicable.

### SEQUENCE LISTING OR PROGRAM

Not applicable.

### BACKGROUND OF THE INVENTION

1. Field of Invention

Shared databases—containing such information as business locations, personal contacts, frequently-asked questions and their answers, dictionaries, event-listings, movie catalogs and music reviews—are becoming more valuable as the internet becomes more available to consumers: at home, work and on mobile phones.

We illustrate below aspects of assembling large, widely-used databases by using a specific example—location databases—but the invention relates to a wide variety of shared information, including the examples mentioned above.

Location specific information—information indexed by geographic position—can be very useful for navigating to a location, monitoring events near a location, initiating social interactions, and locating nearby services. Some existing mobile terminals—such as vehicles with navigation computers, mobile phones, personal digital assistants and handheld map devices—have the ability to fix their location using real-time geopositioning. When combined with pre-gathered location-specific information, users can obtain maps, directions to and from their current location, and information on nearby venues.

One mechanism for delivering location-specific information transmits a large collection of information from a centralized location-specific directory to the mobile terminal, as a one-time or updatable process like purchasing a new map. This “download” delivery mechanism has been used to provide maps or points-of-interest for navigating the highway system, or locating venues along a travel path.

A better situation arises when a mobile terminal with positioning also contains the ability to communicate data through the Internet. In this case, portions of large databases and stationary computing resources can be accessed on-demand through the Internet, using the mobile terminal solely for fixing its geographic position and providing a user-interface. For example, a mobile phone can request nearby movie locations and times through the Internet when a subscriber wants to go to a movie, saving the phone from keeping a full database of all movie locations and times.

At present, professional organizations compile most location-specific databases—editing the database carefully over a period of months before releasing it for use. Trained database entry and cartography staff may enter data into the database, or bulk-load external data purchased from a known source. Untrained individuals typically are not allowed to enter or augment the data in location databases.

Professional editing of public data leads to five problems: First, to assemble, train and use a professional staff is expensive. For example, trained staff, once they know the names and locations of points-of-interest in a region, may rapidly enter accurate location information about that region. However, trained staff members who have not frequented a region must take the time to learn about those regions—and the time required to learn about the region costs money.

Second, professionally edited databases may go out of date rapidly. For example, roads have temporary detours, new businesses are established, existing businesses move or close, concerts and conferences exist only briefly in a location. Unless many regionally distributed staff members work diligently to maintain and release the database to subscribers, much of the location information in the database may go out-of-date soon after making it available. In some cases, the location-specific information is so ephemeral, such as detours, that professional editors don't bother trying to supply it.

Third, professionally edited databases-especially databases covering many items—can be inaccurate because the editors have no personal stake in the accuracy of that data. For example, although Joe is not a trained cartographer, he lives in Yreka, Calif. He would likely provide more accurate information about the operating hours of the Yreka Bakery than a professional cartographer located in Chicago, Ill. If Joe was the owner of Yreka Bakery, the accuracy of the data is likely to be even higher.

Fourth, professionally edited databases may provide only the most basic information. For example, professional location databases rarely provide operating hours, movie times, band line-ups, game schedules and other information that would be valuable to mobile consumers, simply because the cost is too high to hire professionals to maintain reasonably valid information. In some situations, there may be no way to even partially recoup the cost of maintaining a database. For example, it would be difficult to find a business model supporting an Internet directory listing all places of worship in the United States with service-times.

Fifth, professionally edited databases tend to provide information of uniform quality and value regardless of how often the members of the community need the information, because professional staff may not understand local behavior patterns. For example, a community may present theatrical plays in a private home. A professionally edited location directory may omit the home, even though local people regularly need directions to it.

As the Internet becomes more widely available, through desktops, laptops and mobile terminals, consumers will demand less expensive, more accurate, more up-to-date, more informative and more relevant information. In many cases, professionally-edited databases cannot feasibly accommodate their needs. Large enterprises may face similar problems, especially if many staff members with limited training need to participate in data collection efforts as a peripheral part of their jobs.

2. Objects and Advantages

Besides the objects and advantages described above, the following are also objects and advantages of the present invention:

a) It allows communities of people to maintain self-managed directories of information, for example about people, businesses and other locatable assets.

b) It allows communities to avoid the cost of professional catalogers

c) It allows users to gain value, and possibly positive recognition, from a locally accurate location directory.

d) It naturally motivates data sources, especially if associated with community members, to enter high-quality data into the directory, in some cases without monetary compensation

e) It allows the business or person who controls the item being cataloged (the “controlling interest”) to author the database information for that item,

f) It allows non-controlling interests to author database information for that item. This is particularly helpful when the controlling interest in the item is rarely online, or has minimal interest in online users. Such non-controlling interests can include consumers, partner businesses, friends or other third parties.

g) It can maintain high quality by measuring the quality—as perceived by other community members or users of the data, or implicitly rated by the corrections applied—of each author's data items, and then assigning a quality ranking for the author as a whole.

h) It can provide feedback to authors about the perceived quality of their submissions

i) It can enable a system to reward prolific, high-quality authors—as determined by the number of references to their contributions, and the lack of corrections applied to those contributions—by rapidly accepting their submissions, or by some other means.

j) It can punish poor authors by delaying acceptance of their contributions until better ranked authors or an editor confirms the contributions, by disallowing any contributions from them until some time has passed, by blackballing those authors, or by some other means.

k) It allows a consumer to gain access to the most up-to-date information.

l) It reduces typing and transcription time in many circumstances, for example when people are updating a contact folder, because only one person has to enter information that many people use.

m) It provides that multiple web sites can use the directory through a web service, allowing each web site to take advantage of information entered on the other web sites.

n) It provides that only one person need author an address for a location, and others can download that information to their contact folders or otherwise access the location without having to author it themselves.

o) Since users have more local expertise, a community location directory could feasibly include more complete and timely information, such as when businesses are open, when events might occur, particular acoustic aspects of a venue, etc. This can make a community location directory more valuable than a professionally-edited location directory.

p) It can augment existing data from an existing professionally-edited location directory. For example, the locations and names of businesses can come from the professionally-edited location directory, while the operating hours can be provided by users. A professionally-edited location directory could provide the initial seed data for a community location directory, and then users can correct that data as it goes out of date. A professionally-edited location directory could provide commercial or military information, while users augment it with information relating to community assets, such as recreation facilities or community events.

q) It can include private location items that are only personally relevant, such as “when mobile user Joe is in the vicinity of 330 Townsend Street, mobile user Joe is likely to be in Suite 209.” Such private location items would allow users to find personal resources easily.

r) It can help emergency personnel locate a person more quickly. Some existing positioning systems, such as GPS, are not accurate enough to locate a person within a large building, or even designate a specific building when the buildings are small. So a person's private location items could also help emergency personnel, friends and service providers locate that person.

s) It can help free users from having to remember the areas they have previously entered, or having to check to see if the area they are visiting has already been entered into the database.

t) Designating regions instead of points for geographic points-of-interest has advantages: If a user is inside a large building, but farther from the point associated with the large building in a point-of-interest database than from the point associated with a smaller adjacent building, the system could identify the user being inside the smaller building. This could interfere with rescue attempts, or cause problems for adaptive personalization algorithms that characterize a user based on the locations the user visits.

### SUMMARY

It is an object of the invention to substantially overcome the limitations of professionally edited databases and fulfill the above identified needs.

The invention is a collection of technologies that enable untrained users or unqualified data sources to enter, update, validate, correct and delete data in a community directory. The invention can maintain higher quality information than would be possible in an uncontrolled directory, where anyone can submit information. In some cases, the system can maintain higher quality information than can be cost-effective in a professional directory.

One embodiment of the invention is a simple community directory that could be built using a database server, an item table associating each item in the directory with a primary key, a field-table indexed by item-id and field-id where each row contains a field-value, an API allowing programmatic access, and an appropriate data source interface allowing users to enter, find, correct and delete location information from the database. Such a system would provide basic functionality, but would not distinguish between good, malicious and sloppy contributors, so the overall quality of the database may become low.

Another embodiment of the invention is the first embodiment with the addition of a source table, and the addition of a column in a field table indicating which source contributed the last value for the field. The source table could reference a histogram of the number of corrections against the source's contributions ordered by the time of the contribution, and another histogram of the number of contributions the source made ordered by time of the contribution. When the ratio of corrections to contributions for a source in a time period exceeds a maximum error rate threshold, which may depend on the age of the contributions such as shown in FIG. 1, the system may prevent the source from creating new entries or modifying existing entries in the public database. As time proceeds, the age-based maximum error limit may become more relaxed, allowing the source to again submit new entries. This has the effect of providing a temporary punishment for poor contributions. FIG. 1 depicts such a limit.

Another embodiment of the invention is the previous embodiment with the addition of a column in the item table indicating which source owns the entry. If no one owns the entry, the system considers the item to be public. When a source owns the item, it becomes a private item available for use by that specific source. The owner may view, modify or delete the item without affecting other sources. If the item table contains a link column, a source may link a private item to a public item. In this case, the private item may contain fields or field-modifications that are not available to other sources. Public items have the advantage that other sources may update the information, making them more up-to-date. Private items or fields have the advantage that others cannot view the information, and do not put the owner's reputation at risk. Someone might decide to store a home address as a private item, for example. Or they may make a private link to the public item storing the address of a Chevron gas station, where the private link modifies the name to be “Bob Smith's Gas Station,” for example.

A further embodiment stores locations as items, which a source can search by proximity to a geographic position. In practice, assisted GPS (A-GPS) equipped phones can locate themselves with 5 to 20 meter accuracy. This can free a mobile terminal user from typing in location landmarks, such as nearby cross-streets, or a specific address, making it more likely that a user would be willing to enter location information.

Another embodiment is a system that tracks the source's location periodically, and when the source is in a location where there is no entry in the directory for longer than some time limit, the system automatically prompts the source to enter their location into the community location directory, as either a public item or a private item.

Another embodiment of the invention is a system where the source is a device, such as a vehicle, and the system constructs a directory that consists of routes of those devices.

Another embodiment of the invention is the first embodiment, with the ability to enter a location region using satellite imagery, a graphical display and a pointing device.

Another embodiment is a system where the source is a user's contacts folder, allowing many users in a community to create a shared contacts folder that preferentially includes information from those contacts folders that contains the best information.

Advantages

When any user can contribute entries in a community location directory, malicious or sloppy contributors can introduce errors. Therefore, there is a need for other users to verify and correct public information stored in the community location directory. Furthermore, when a contributor has had numerous corrections applied to his contributions, the system should limit that contributor's impact on the directory to preserve its overall quality. Finally, when the system has limited a contributor's ability to enter new data into the directory, there should be a mechanism for a contributor to redeem him or herself by making contributions verified by others to be accurate.

Consequently, users need a means to easily and accurately input, verify and change location-related information in a location directory, to share such information publicly, to create private items only accessible to the owner, to have the system automatically predict the quality of different contributors to the location-directory, and to limit directory modifications that arise from historically malicious or sloppy contributors. Such a directory can be used to find an individual within a building, to find temporary venues or venues that are open at specific times, to find new businesses, and avoid finding closed businesses, to get temporary routing information related to detours or congestion, and to inexpensively create location directories for general use.

### DRAWINGS

FIG. 1 depicts an error rate overlaid with a submission threshold.

FIG. 2 depicts a high-level architecture for a mobile location directory.

FIG. 3 depicts a possible architecture of a community location directory.

FIG. 4 depicts a possible set of data objects used to implement the system.

FIG. 5 depicts a partial hierarchy of venue categories in a location classification system.

FIG. 6 depicts an interaction sequence for venue insertion.

FIG. 7 depicts a flow chart of item insertion, modification and correction logic.

FIG. 8 depicts a sequence diagram of low-level venue insertion processes.

FIG. 9 depicts a flow chart of the venue classification logic.

FIG. 10 depicts an interaction sequence for venue verification.

FIG. 11 depicts a sequence diagram of the low-level venue verification processes.

FIG. 12 depicts an interaction sequence for venue modification.

There is no FIG. 13.

FIG. 14 depicts a sequence diagram of the low-level venue modification processes.

FIG. 15 depicts an interaction sequence for venue correction.

FIG. 16 depicts an interaction sequence for venue deletion.

FIG. 17 depicts a submission histogram useful for calculating reputation.

FIG. 18 depicts an error histogram useful for calculating reputation.

There is no FIG. 19.

FIG. 20 depicts a flow chart associated with calculating submission reputation.

### DETAILED DESCRIPTION

I. Overview and General Architecture

The invention refers to a community directory of location-specific and temporally appropriate information. The term “community information” refers to information that is provided by end-users rather than service personnel hired to gather, edit, or enter location-specific information. Therefore the invention includes additional facilities to classify new entries provided by end users, generate personal placemarks of individual users, validate new entries, modify, correct and delete private and public entries, and control the ability to contribute to and make corrections to location entries based on the quality of contributors. These components make it more feasible for untrained people to create, as a community, an accurate location directory.

The following entities are relevant to the system:

Directory: Structure and related processing mechanisms used to store and retrieve information using search criteria. A directory can be implemented using a database system.

Mobile Station: A specialized mobile device with the ability to display text or graphics to a user, and the ability to communicate data by wireless means.

User: In preferred embodiments, a person authenticated through a login procedure or through use of a personal mobile station.

Source: A source of item values that has an identity. A user can be a source.

Point: A longitude, latitude and optionally altitude with accuracy information.

Path: A group of connected points describing a geographic area.

Region: A bounded geographic area.

Point Of Interest: A geographic entity with a fixed position, defined as a point, a group of points, a path, or a bounded region, typically identified by name rather than by address and characterized by type that is a functional description describing a product or service, and can reached by a mobile-device user through any form of transit or locomotion.

Time Period: An extent of time set off by a start and end time or duration.

Availability: A set of time periods indicating when a point of interest is usable (could be “always”).

Category: A description for an item that uses a sequence of descriptive keywords (such as “restaurant.french”) to describe a path through a classification hierarchy. The descriptive keywords can be qualitative.

Venue: A point-of-interest designated by a name, geographic description, availability and set of categories.

Event: A temporary point-of-interest that has an event name, an associated venue, a defined duration, availability, and set of categories.

Item: An entity in a community database that can be inserted, modified, corrected or deleted by users. Venues and Events are examples of Items, but other entities-such as frequently asked questions and corresponding answers, musical selections, movies, contact information—can also be items. Items may have multiple field values.

Insert an item: Add a completely new item to the directory.

Modify an item: Introduce new fields to an item in the directory, but not change existing fields.

Correct an item: An operation combining at least one substitution of a new value for an existing field value in an item, with any number of new fields. In some embodiments, corrections of an item may be marked “pending” until other users confirm.

Delete an item: Removal of the item from the directory. In some embodiments, the deletion of an item may be marked “pending” until other users confirm.

Reputation: An object relating to a user's history used to determine whether he or she can submit new item information to the directory (“submission reputation”) or make corrections to other user's items (“correction reputation”). Reputation in this discussion is expressed through use of a “limit condition” or “limit function” on a user's history.

Author: An author is one of the last users to have modified a part of an item. In some embodiments, the author of the part is the last person to have modified the item in any way. In some embodiments, items are composed of multiple fields and the authors who last added, modified or deleted any of the fields in the part are considered the authors. In some embodiments, each character in a document can be associated with a specific user, so the authors of the part would be any user associated with the characters contained in the part. Identifying authors is important for the invention, because the reputation mechanism maintains directory quality by punishing authors when their information is corrected, and rewards authors when their information is used.

Reference: References to an item or part of an item measure the “utility” of an item to members of the community, in part to compute the reputation of the author of the item. In this embodiment, a reference can be a link from another user's private item to one of the author's public items. In other embodiments, references could also be computed by simple counting the number of times another user viewed an item, or by the number of times an item was mentioned in a text document, etc.

Using these definitions, the term “location-specific information” refers to information that describes a particular venue or event. The term “temporally-appropriate information” refers to information that is viable for a specific time period. Item classification follows a semantic organization and refers to a hierarchical means of ordering items using functional information about the item. It should be noted that the term “hierarchy” relates to logical relationships and should not be construed to mean the data type or physical organization used to represent the collection of items. Those skilled in the art know other means of representing the collection, and the invention does not depend on a specific means.

There are eight functional capabilities used to implement a community contributed directory of interest in this discussion: (1) insertion of new item information, (2) verification of new item information, (3) classification of new item information, (4) modification of existing item information, (5) correction of existing item information, (6) deletion of existing item information, (7) retrieval of existing item information, and (8) control over who can submit or modify item information. New item information can take the form of a public item or private item. There is a need in the art to associate new item information with a set of categories so that it can be stored, analyzed and retrieved based on category, such as finding nearby events under the classification “hiphop.dance”. When two or more users provide contradictory information regarding an item, there is a need in the art to compare the estimated quality of the information, in part by evaluating the credibility of the users. The present invention provides solutions to both of these needs.

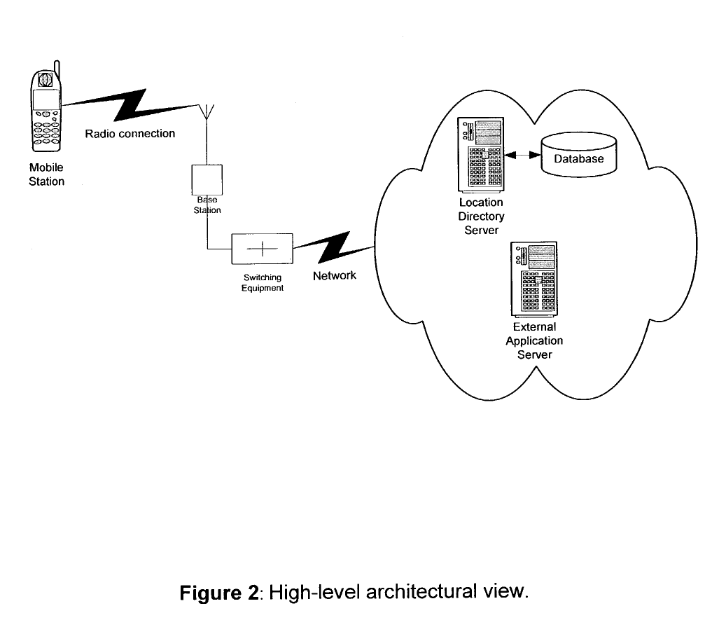

A general architecture supporting the development of a community directory is depicted in FIG. 2.

FIG. 2 shows the equipment that could be used in an embodiment of the invention. Suppose a user presses a button on Mobile Station directing an application running on Mobile Station to enter location information in a Location Directory. Mobile Station sends appropriate communication data packets through a Radio Connection to a Base Station, which then routes those packets through Switching Equipment and a Network to the Internet. Those packets can then be directed to the Location Directory Server, which processes the packets to insert, modify, correct, or delete entries in the community location directory.

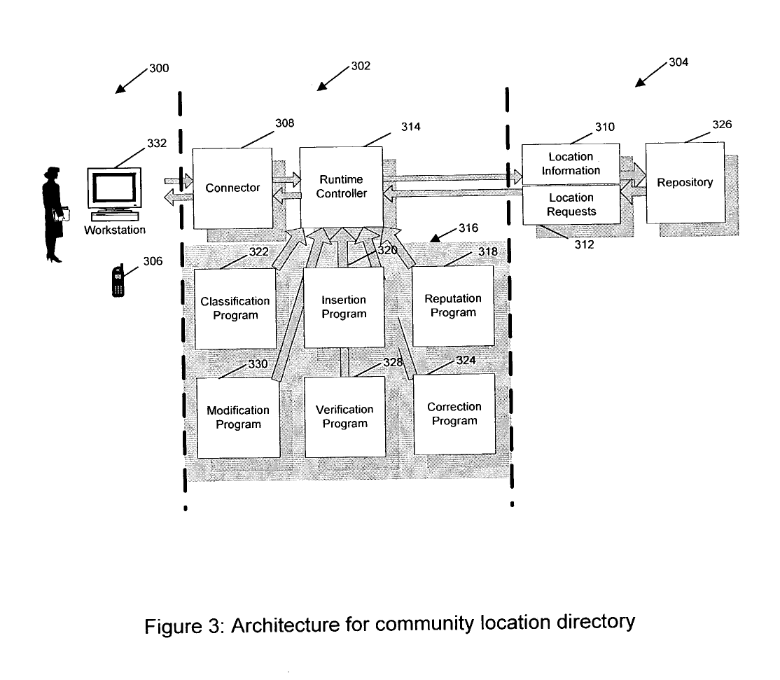

FIG. 3 depicts an operating environment that is useful in the practice of the present invention. The environment can be divided into three partitions: front end 300, location data processor 302 and location back end 304. Front end 300 is the environment in which a user interacts with the present embodiment location, via mobile device interface 306 or stationary device interface 332. Front end 300 is connected to the location data processor 302 for data communication via connector 308. Connector 308 may be a combination of the radio connection, base station, switching equipment and network connection depicted in FIG. 2, an internet connection, or some other networking system.

A user often connects to a site whose interface of first impression is a mobile device interface 306 or stationary device interface 332. For example, a customer visiting the location page for a particular venue might first see and interact with a mobile station interface.

In the operating environment that hosts the embodiment of the present invention, device interface 306 instantiates a process that communicates with location data processor 302 via connector 308. Location data processor 302 itself comprises connector 308, location runtime controller process 314, and a set of location-specific programs 316. In the current embodiment, location data processor 302 is implemented with a webserver/application server combination, though many other mechanisms are known to those skilled in the art. The data storage medium as well as the memory of the computer may contain digital representations of the location directory, or parts thereof. The data storage medium may be removable. Such processing components, data storage devices, and data storage medium, are well known in the art and are not explicitly shown in FIG. 3 to avoid obscuring the drawing with unnecessary detail.

As a user logs onto a site having location data processor 302, via connector 308, runtime controller 314 executes interaction routines that guide the interaction that occurs between the user and location data processor 302. A two-way interaction occurs between the user and location data processor 302 wherein the user, in addition to the positional information provided by the mobile station, may request or provide location-specific information pertinent to that position. Location specific data 312 provided in descriptive information provided by the user are then incorporated into the backend 304. Location specific data 314 provided in response to user requests are returned. Both are mediated according to a set of location-specific programs 316. Location-specific programs 316 are created for the purpose of inserting new information into the directory, verifying information prior to insertion, classifying new data prior to insertion, modifying information in the directory, correcting information in the directory, determining who can insert or modify data in the directory, or retrieving information from the directory.

As the interactions between a user and runtime controller 314 continue, it is generally desirable to engage in quality control of location-specific data 312. This quality control is provided location data processor 302 via an interaction loop controlled by a reputation program 318, using information in back end 304. Directory content addition and modification events are logged or otherwise retained over time, and this information forms the basis for accurately diagnosing the validity of submissions or corrections, and the credibility of their authors. Such information may be stored electronically in a storage media or could be printed out in human readable form.

Although FIG. 3 gives a general description of various operating environments in which a mobile location directory may exist, it will be appreciated that many other operating environments are obvious to those skilled in the art and that the scope of the present invention should not be limited to the exemplary descriptions as given herein.

II. Community Location Directory

The following embodiment describes a community directory whose entries are venues or events, but the invention may be beneficially applied to other types of shared items as well.

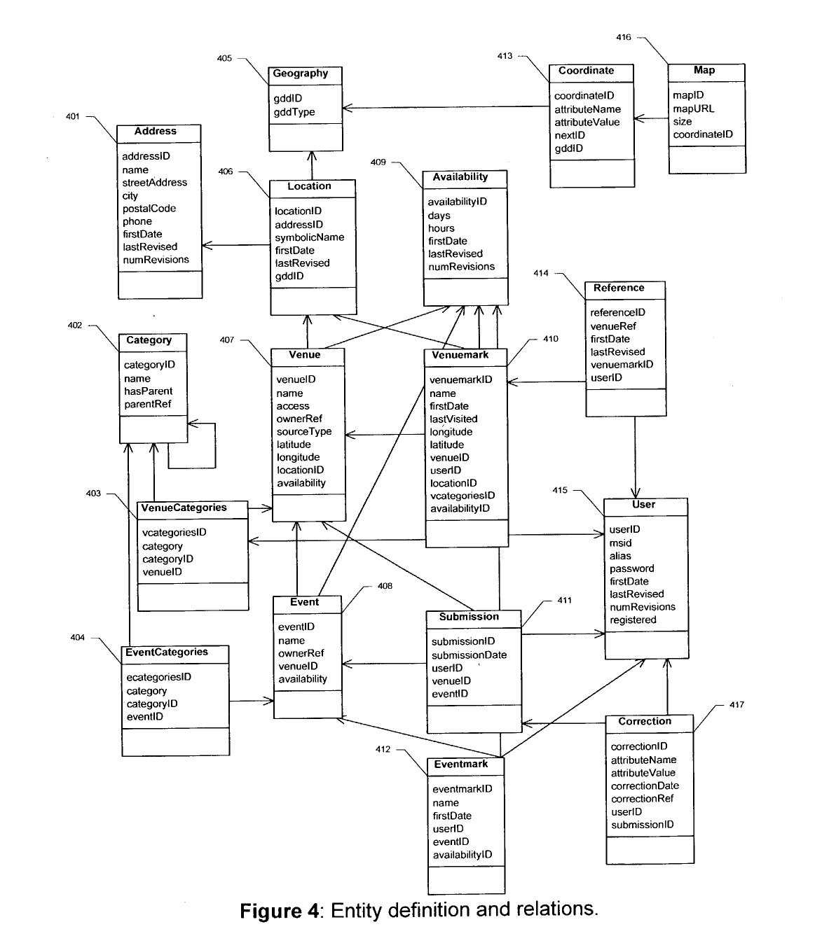

Entries in one embodiment of the community directory 324 may represent venues or events. The organization of entities in such an embodiment is depicted in FIG. 4. The venue entities 407 and event entities 408 are represented by a name, a location, an availability string, and a set of categories. Events additionally reference the venue at which the event takes place. Location entity 406 may have a symbolic name, an address, a geographic description and one or more coordinates.

A geographic location can be determined by requesting it from a mobile station, by sending an identifier (such as a mobile station ID) to a location server and retrieving the result, by having the user enter the longitude and latitude, or by having the user enter an address and geocoding the result. A measure of accuracy may accompany the returned geographic location.

A user may search for items according to criteria. In this embodiment, a user might search for venues of a particular category near a specified location. The system may sort the returned items with an appropriate metric when presented to the user. For example, the system may sort venue information by distance from a location, or by travel time relative to the user. In this way, a user can readily access all of the items at or near a position. The remaining sections describe the structural foundation and the interacting mechanisms for this system.

A. Hierarchical Decomposition of the Universe of Items

In an embodiment employing the invention, all items fit into a classification hierarchy referred to as the “universe of items” (a similar classification scheme can be used for events). Elements of the hierarchy are qualitative categories represented by keywords. Every new item inserted into the directory using this scheme falls into one or more existing categories, or into an “other” category, so that users can later retrieve the item based on those categories. The system may periodically update the universe of items to resolve “other” categories. The organization of such a classification hierarchy is top-down, and general-to-specific.

FIG. 4 depicts a universe of venues and events as a set of ontological objects 407 and 408, where each category has a keyword value and, if the category has a parent category, a foreign key to the parent category. A Category 402 is fully described by its “category path” a concatenation of the name values along a path to the root category linked by non-null parentRef member values. Thus, entities in Category 402 represent an ontology.

Given a classification hierarchy that covers the breadth and depth of a universe of items, users can classify item information in a community directory. Subsequent searches can be limited to items that have a particular category sequence, such as “find restaurant” or “find italian.restaurant,” as a substring in their category path.

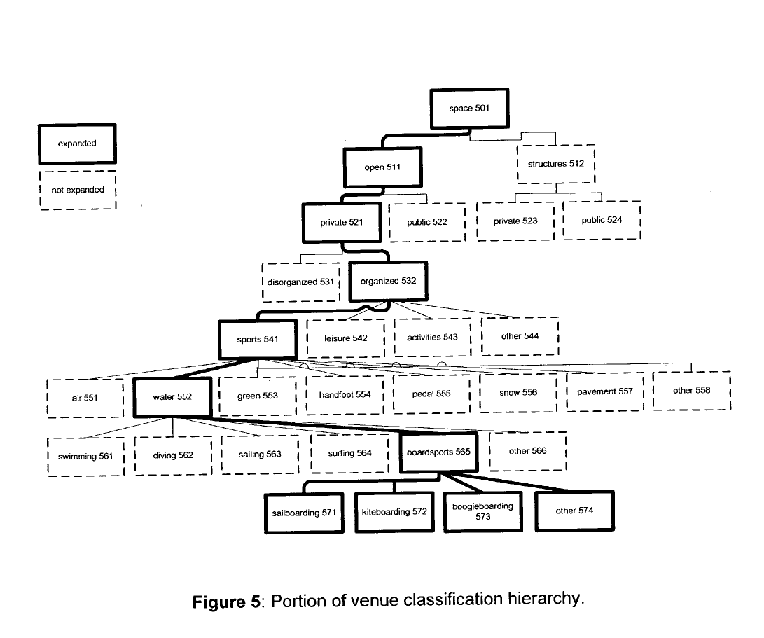

FIG. 5 depicts part of a possible classification hierarchy for a community location directory. The portion shown illustrates types of relationships that might exist between categories in the hierarchy. A complete hierarchy would be an exhaustive representation of keywords allowing classification of many or all new additions to the directory. FIG. 5 shows an “inheritance” hierarchy in that items further down in the hierarchy inherit the properties of those above them. In the notation of hierarchical decompositions, every keyword represents a item category. A terminal in this decomposition represents a category that hasn't been subdivided. In some embodiments, items are associated with terminal keywords. In some embodiments, items may be associated with non-terminals. In some embodiments, some items may be unclassified. In FIG. 5, sailboarding 571 is a terminal keyword. Privately owned/operated sailboarding venues would have a category path originating at sailboarding 571 and terminating at the root of the hierarchy, as in “sailboarding.boardsports.water.sports.organized.private.open.”

An item may be associated with multiple categories. For example, a restaurant might serve both Japanese and Korean cuisine, in which case the corresponding item might be associated with both restaurant.japanese and restaurant.korean categories. Therefore, FIG. 4 shows each venue associated with a collection of venue categories 403. In a similar fashion, a rave might be associated with a music genre (“Drum and Bass”) and a dance genre (“Rave”). Thus, FIG. 4 shows each event associated with a collection of event categories 404.

Universes of items are organizational mechanisms only, and may be implemented differently in other embodiments. Practitioners of the art may use other classification mechanisms in different embodiments of this invention.

B. Geographic Input

Several operations described in this embodiment require input of a geographic location. The geography input defaults to point input. If the geography type selected is other than point, then the user is prompted to input the geography based on the type and also based on the input capabilities of the user's mobile station. In the case of non-point geographical representations, a map, photograph or satellite image of the area around the user's position may be displayed on the device user interface and the user selects the points, path, or region describing the geography using an input device. Aerial maps 416 may be retrieved for the purposes of determining path and region geographic representations, and may be stored locally on the mobile station while the new venue or event information is being entered, and until verification has been completed.

C. Item Insertion

Item insertion is a mechanism enabling a user to add new item information to the community directory. In this embodiment, users with GPS-enabled mobile stations perform insertions to a community location directory. However, any network-enabled device can be used in the present embodiment if a user enters the item's geographic position or the system otherwise computes it. Entities 407 and 408 describe venue and event items in this embodiment. A Venue may include a name, a geographic description, a temporal availability, and zero or more categories. Temporal availability may be represented by specific days, days of the week, times of day, duration or other indicators when a venue/event is accessible. An Event may include a name, a venue where it is located, a temporal availability, and zero or more categoriess.

A geographic description can be a point (such as a longitude-latitude pair or a longitude-latitude-elevation triple), a group of points, a connected path of points, or a bounded 2-dimensional or 3-dimensional region. In FIG. 4, a geographic description is represented by type and by a collection of Coordinates, as part of Location 406. Two representation constructs, a single point, and a polygon, are used to describe all geographic entities. Point representations are used to describe venues with a single position. A geographic description can also be represented with a polygon, where the coordinates representing the geography are identified from the mobile station using a map 416 of the area near the venue. Other types of venues can have their geography represented with groups of points or paths of connected points using a map in a similar manner.

Items may have private or public visibility. Private items are visible to one or more specific users, or users in specific roles. Public items are visible to everyone in the system. Searches could specify whether to look for private or public items. These different items may be stored in the same table, such as by having a designated ownerRef value to represent public, or public and private items may be stored in different tables. FIG. 4 shows public and private items stored in separate tables, where Venue 407 and Event 408 are public, while Venuemark 410 and Eventmark 412 are private.

After a user (author) inserts, modifies or deletes a public item, other users (reviewers) interacting with the item can increase or decrease the reputation of the Author. Authoring a public item can benefit the author because reviewers can help keep information about the item up-to-date. In addition, the author may benefit from public knowledge of the item, such as if the author inserts an item describing his music club. Finally, in some embodiments authors might be compensated in some way. Therefore, authors are often motivated to enter public items.

Private items may link to public items. In such a private link, when private information has been specified, the owner of the private link sees the private information. When some information is omitted in the private item entity, the owner of the private link sees the public information. Such private links can be stored in the same tables as private items, as shown by entities Venuemark 410 and Eventmark 412.

Insertion Process

The process of inserting new information can be initiated one of three ways:

1. The user initiates the process by requesting to insert a new item in the user interface

2. The user initiates the process by requesting information about an item and finding it doesn't exist in the directory.

3. The system initiates the process by a triggering event. In the case of a community location directory, the system might monitor the users' location periodically, and determine a) that the user has been in the same location for over a preset time limit; and b) that the user is in a location not represented in the directory or information for the current location is sparse, old or qualifies in some other way.

The system then may gather some information, perhaps by automatic means, such as requesting the mobile device location through a location server, by requesting some information from the user, such as asking the user for a particular category, or by some predictive means, such as guessing the category from previous user entries.

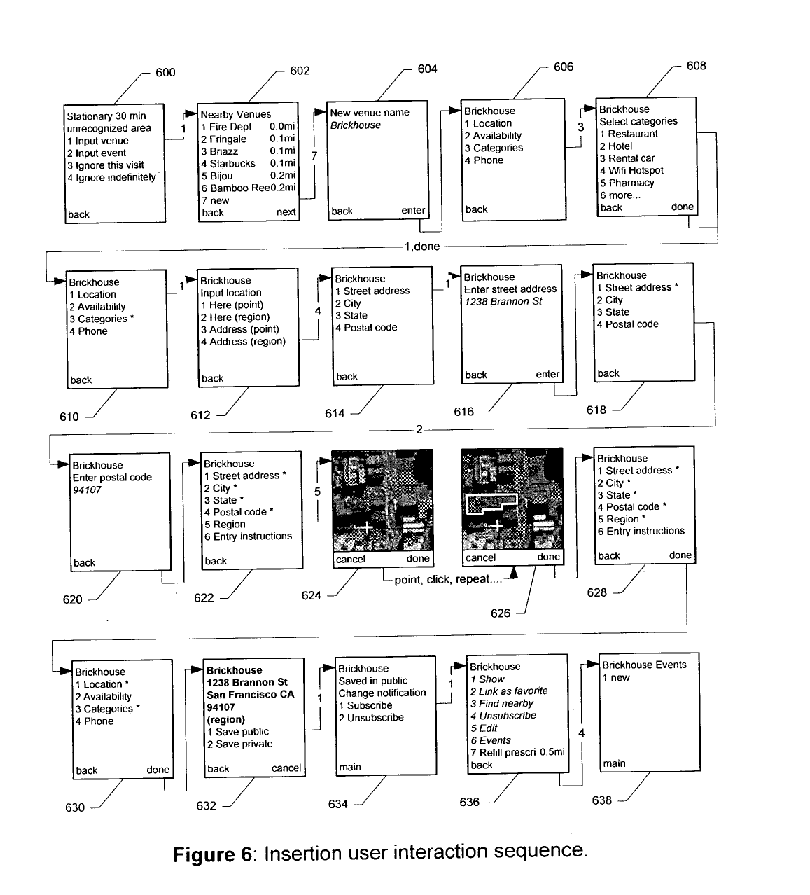

FIG. 6 shows an example interaction sequence between a user and the system. Screen 600 shows the system detected that the user was stationary for over 30 minutes in an unknown location, or in a known location at a time the location is considered “unavailable.” The system gives the user 4 options: Option 1 allows the user to input a venue. Option 2 allows the user to input an event that is happening at the current location. Option 3 tells the system to stop bothering the user during this visit, but during a later visit to the same location the system may prompt the user again. Option 4 tells the system to never bother the user again at this location. In the example, the user selects 1 to enter a venue.

The user interface may suggest existing items already in the directory that might already represent what the user wants to enter. For example, the system allows the user to select venues near the user's current location or enter a “new” venue at screen 602 in FIG. 6. The user elects to enter a new venue by pressing 7. At screen 604, the user enters the name of the venue. At screen 606, the user presses 3 to classify the venue as a set of categories. At screen 608, the user selects the “restaurant” category by pressing 1, and then ends the selection process by pressing enter. The system returns to screen 610, which then reflects that the user entered a set of categories with an asterisk next to the categories selection.

The user then presses 1 at screen 610 to enter a location. Screen 612 gives the user several options. If the user presses 1 or 2, the system will request the location from a location server or the device to determine the geographic location. If the user presses 3 or 4, the system will prompt the user to enter an address, and then geocode the address (convert it to latitude and longitude) to determine the geographic location. Selections 2 and 4 specify “region” instead of “point.” When the user selects entering a region, the system prompts the user to outline the region on an aerial image or map. This can help the system determine when a user is inside a building or region.

The user presses 4 at screen 612. Screen 614 provides options to enter the address, but does not provide an option to enter the region or entry instructions (see screen 622). This is because the user must pick a point first, around which an image or map can be displayed, or entry instructions apply. In screens 616, 618, and 620, the user enters the address. Because the user entered a postal code in screen 620, the system could determine the city and state as shown by asterisks in screen 622.

In screen 622, the user presses 5 to input the region. In screen 624, the system displays the region as a satellite image. At this point, the user manipulates a pair of crosshairs or another visual indicator to select a sequence of points for the region. Screens 624 and 626 in FIG. 6 show the crosshairs faintly. A user moves the crosshairs by using a mouse, by pressing numeric keys (such as 2=up, 4=left, 6=right, 8=down), by using a track pad or by some other pointing mechanism. The user selects a point on the map by pressing a designated key, or by clicking the mouse. Depending on the embodiment, a region can be composed of multiple disjoint polygons. The user can close the perimeter of a polygon by clicking on the starting point of a polygon, then the next click indicates the beginning of another polygon. Double clicking or pressing “done” can indicate the completion of the polygon. Practitioners in the art are familiar with several other methods of indicating polygon regions.

From screen 624, the user made 9 clicks to outline the region shown in screen 626. Upon pressing “done” in screen 626, the user indicates completion of the region.

Screen 628 indicates with asterisks that the user has input all fields except “entry instructions.” The user chooses not to input entry instructions by pressing “done.” Screen 630 shows that availability and phone have not been input, but the user chooses not to input these by pressing “done.”

Screen 632 shows some of the information entered about the location, and allows the user to store the location in the public community directory by pressing 1, or to store it in their private directory by pressing 2. In this embodiment, the option to store the location in the public community directory will not be offered by the system if the user's past submissions have had too many corrections, so in this example the limit condition succeeded for the user.

The user presses 1 and the system stores the venue in the public community directory. By placing the venue in the public directory, the user allows others to enter more information about the venue, such as its availability (operating hours) or its phone number. Should the information change, such as expanding into an adjacent building or moving to a different address, other users can revise the information.

Screen 634 gives the user the ability to subscribe to change notification. By pressing 1, the user indicates a desire to receive email or instant-message notification when this venue changes. For items in a public directory, this can help ensure that honest users can quickly reverse malicious changes.

Screen 636 displays the newly added Brickhouse venue, along with operations defined on the venue. In some embodiments, a user can define venue or category-specific operations. In this example, no venue specific operations are defined for Brickhouse, but three general venue operations—Show, Link as favorite, Find nearby, Edit and Unsubscribe—are defined. Pressing 1, “Show,” displays the information associated with Brickhouse. Pressing 2, “Link as favorite,” places a link from the user's private venue directory to the public Brickhouse definition. Pressing 3, “Find nearby,” searches the public and private venue directories for nearby locations (resulting in a screen similar to 602). Pressing 4, “Edit,” allows the user to modify the entry. Pressing 5, “Unsubscribe,” allows the user to stop receiving notifications when the Brickhouse venue item information changes.

Screen 636 shows that there are venue-specific operations defined nearby. For example, by pressing 6, the user can refill a prescription online and pick it up at a location 0.5 miles from Brickhouse.

Once the user selects or inserts a venue, the venue information can be displayed on the user's device along with a “new event” option. If the user selects adding a new event, the process continues much as for entering a new venue. For example, the user could be prompted to provide the following information about the event:

1. Name of the event.

2. Whether the event will be a private or public item, or both.

3. Set of categories for the event.

4. Temporal availability for the event.

5. Other event specific information.

Because an event is associated with a venue, the name of the venue need not be input again by a user.

In some embodiments, the insertion process may be interrupted, such as by a power outage or radio interference, and resumed later. Some embodiments may store the information entered as a completed item. For example, if radio interference interrupts the example in FIG. 6 at screen 622, the system has enough information to place an entry in a venue directory. In a preferred embodiment, this would be inserted into the user's private venue directory, and the user would find the entry (and be able to further complete it) at a later time.

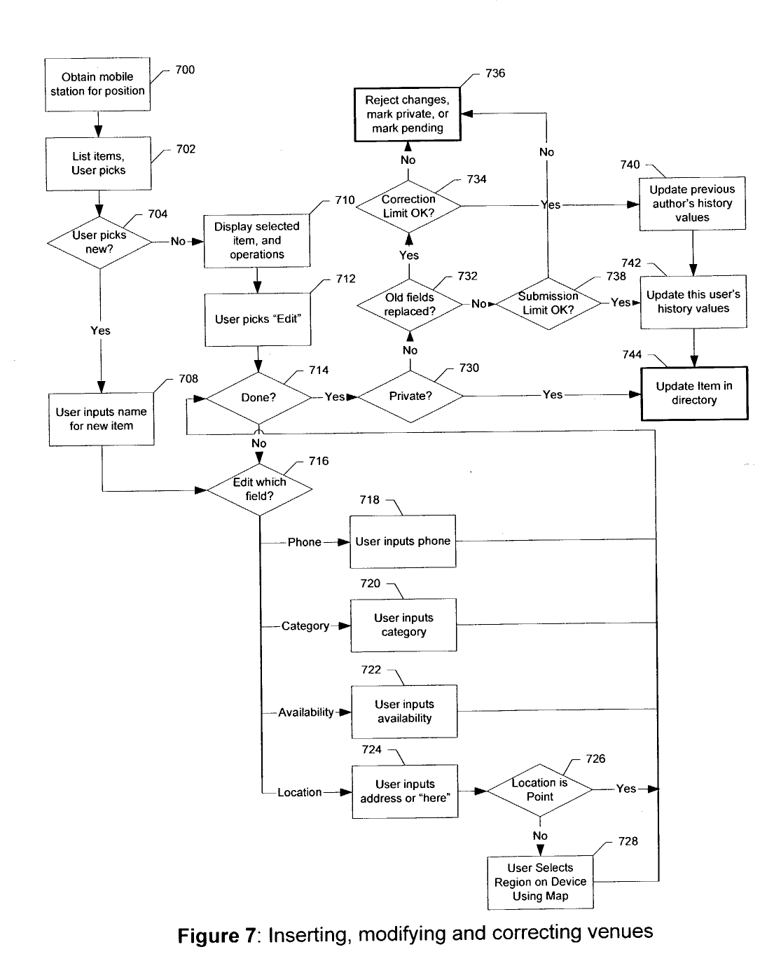

FIG. 7 shows a flowchart for insertion, modification and correction in an embodiment. The insertion process begins in process 702 where the user views venues or events near the mobile station, and in process 704 elects to add a new venue. In process 708 the user inputs a name. In process 716, the user selects a field to edit. FIG. 6 and its corresponding description sufficiently describe processes 718, 720, 722, 724, 726 and 728 in FIG. 7, where the user inputs information for an item.

Process 714 checks to see if the item is done. In this embodiment, a name and a location must be present in the item, and the user must select “done.” When this occurs, process 730 determines whether the item is private. In the case of an insertion, the system prompts the user to decide whether the item should become private or public. If the user selects private, process 744 inserts the item into the user's private item directory. There are several ways to manage private items known in the art. One embodiment inserts a private item into the public directory, marking the item private, associating the user with the item, and making sure that search operations in the system exclude private items not belonging to the user performing the search.

If the item is public, decision 732 determines whether new field values are replacing non-null fields in an existing item. In the case of an insertion, decision 732 is always “no”.

Decision 738 determines whether the current user's history satisfies the “submission limit condition.” This embodiment distinguished between a “submission limit condition” that determines whether a user can insert or modify an item, and a “correction limit condition” that determines whether a user can correct or delete an item.

In this embodiment, the limit conditions are based on past user history. In this embodiment, user history includes the quantity and dates of previous submissions, and the quantity and dates of items authored by this user and corrected by other users. In this embodiment, limit conditions are more likely to disallow an operation as other users correct or delete field values originated by this user. In this embodiment, limit conditions are more likely to allow an operation as this user originates new items or item fields, until the user's total number of items exceeds a maximum, then a limit condition allows no further additions. In this embodiment, limit conditions are more likely to allow an operation as other users link to public items or item fields originated by this user.

If decision 738 fails, the system performs process 736. In some embodiments, process 736 inserts the item the user's private directory, thus allowing the user to find and manipulate the user's own data, but shielding other users from harm. In other embodiments, process 736 inserts the item into the public directory, but marking the item “pending” waiting confirmation from other users. In other embodiments, process 736 rejects the insertion

Although FIGS. 6-7 give a general description of a mobile interaction logic used to perform input operations, various mobile and stationary user interfaces exist, such as WAP/WML, J2ME, HTML, Microsoft Windows, X Windows, text interfaces, etc., that could host this functionality. Those skilled in the art could easily apply other devices and interfaces in reducing the present invention to practice.

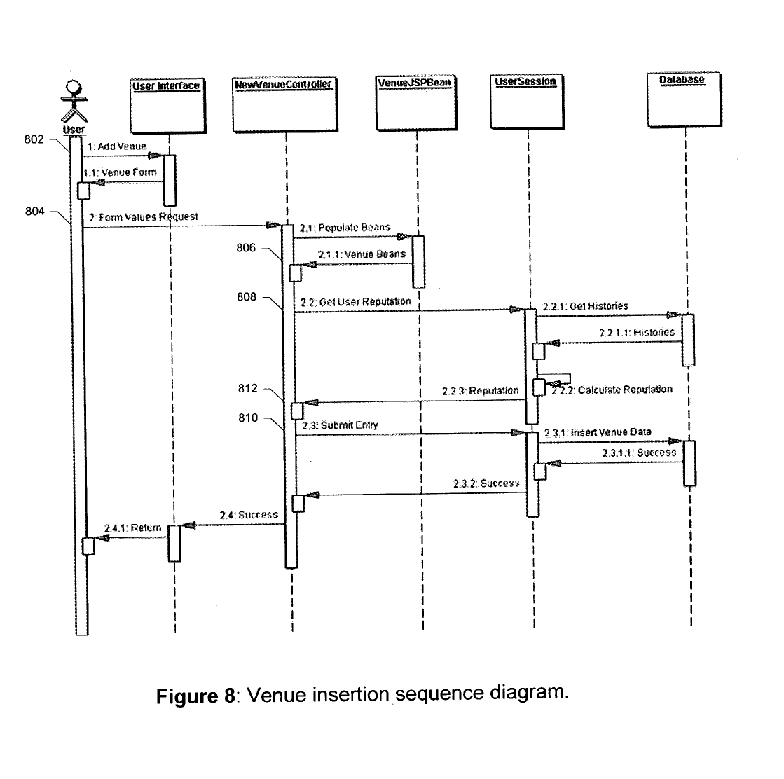

The internal process of entry insertion is depicted in FIG. 8. The entry point to the insertion, depicted as 602, 704 and 706, is implemented with message 802. The data input from the user depicted in 604-632, and 708, 714, 716, 718, 720, 722, 724, 726, 728, 730 and 732 is transmitted in message 804, via Connector 308, converted to Venue Bean objects by Runtime Controller 314 and Insertion Program 320, and returned in message 806. Message 808 transmits the user identity to the UserSession, which invokes reputation program 316 to encapsulate history information—Submission 411, Reference 414 and Correction 417-from database 326 in the form of a Reputation object. Message 812 returns the Reputation object. The NewVenueController then applies the submission limit function to the Reputation object. In this sequence, the submission limit function succeeds, and the NewVenueController then sends message 810 to the UserSession to create a new item.

D. Item Classification

Item classification is a mechanism that enables the categorical search for item information in the directory. There are three cases of interest in the classification mechanism:

1. The item category input by the user doesn't exist in the universe of venues (or events).

2. The item category exists in the universe of venues (or events), but no venue with the current position exists in the directory.

3. One or more item with the same category and current position exist in the directory.

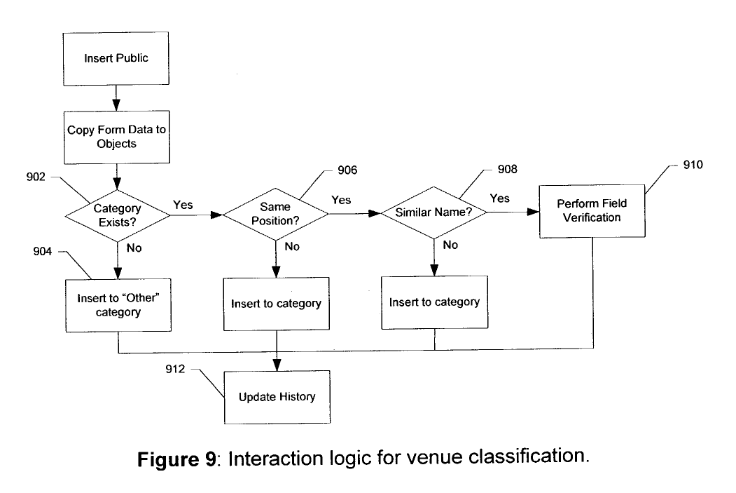

FIG. 9 depicts these cases. During the insertion process the user submits item information through a form or a sequence of forms on the mobile station. This information is transmitted to Connector 308 and is converted into objects by Insertion Program 320. When the submission is approved for insertion by the Reputation program 318, Insertion Program 320 works in consort with Classification Program 322.

If the category does not exist, 902, the new item is inserted with the “other” category 904. If the category exists and there is no other item of the same category in the same location, 906 with a similar name, 908, a new item 407 or 408 is created, from the objects, and inserted into the directory, along with the location 406 and any address 401 or availability 409 information provided by the user. If the category exists and there is an item with a similar name in the same location, 908, then a verification procedure is invoked to compare fields and reconcile conflicts. In all three cases, history information 411, 414 and 415 are updated 912 for future use in calculating reputation.

E. Item Verification

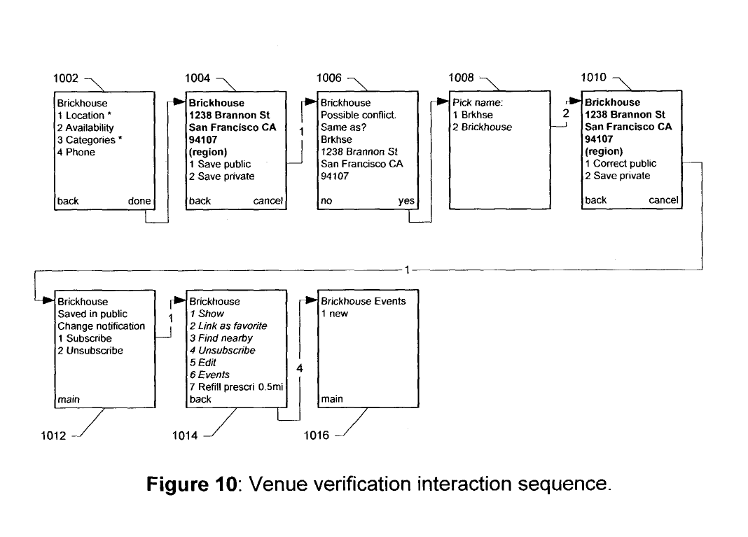

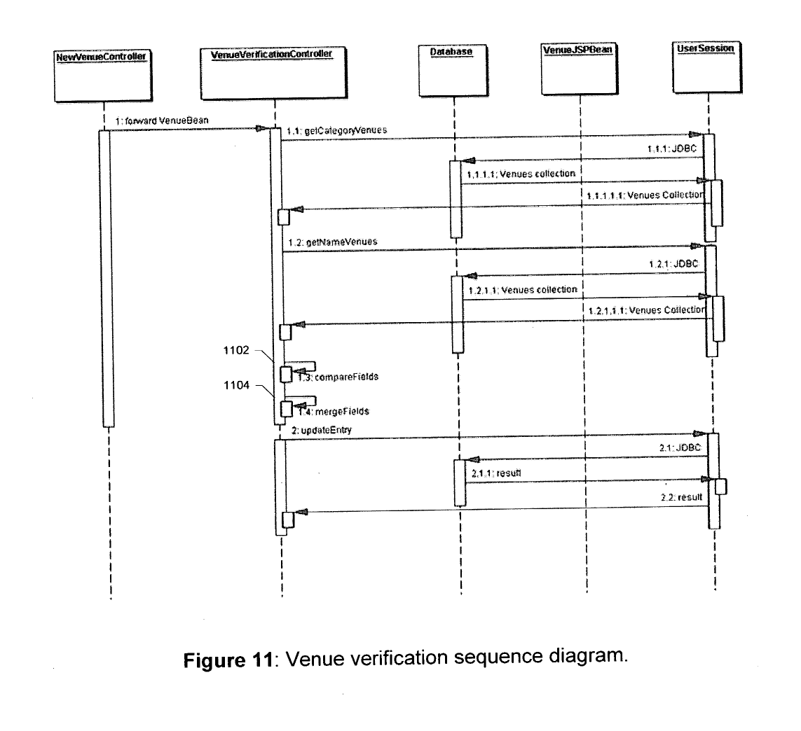

Item verification is a mechanism implemented by the Runtime Controller 314 and Verification Program 328. Item verification identifies whether a submitted item already exists in the directory, and interacts with the submitting user to resolve conflicts between the submission and the existing item. Conflicts can occur when a first user begins a public insertion but perhaps takes longer than a second user. The second user may then insert the same item into the public directory. If the first user later completes the information, and attempts to insert the item as depicted in FIG. 10 screen 1004, the Verification Program 324, shown as a sequence diagram in FIG. 11, interacts with the user in screens 1006 and 1008, to determine which of the conflicting fields is correct, process 1102. During this conflict resolution process, the first user may correct fields in the existing item authored by the second user, as in screen 1010, thereby inserting history information 411, 414 and 415. This can affect the second user's reputation.

The system can merge some conflicting fields without user interaction, as in process 1104. For example, if the first user's submission has a geographic description with more information, such as a region updating a point submitted by the second user, where the region encloses the point, then the Verification Program 328 can select the region description for the final entry. Some embodiments would not consider this a correction to the second user's location information.

F. Item Modification

Item modification is the mechanism that enables an incomplete item to be further completed by the original author or, once an item has been made public, to add information to the item omitted by previous authors. The modification mechanism 324 in FIG. 3 accommodates both situations.

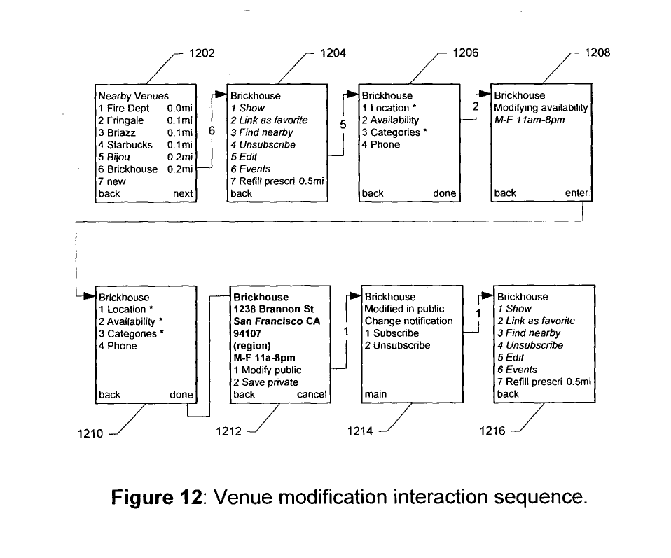

In some embodiments, new items are marked private until a user has provided minimum information for public insertion. The entry shows up as a private item in the user's directory. A user can edit the user's private items with a similar user interface as for public item modifications and corrections. A user can modify public items by retrieving the item information and selecting the “edit” element on the interface. FIG. 12 depicts an interaction sequence to implement item modification. In screen 1202, the user picks the Brickhouse venue from nearby venues by pressing 6. In screen 1204, the user chooses to edit the information by pressing 5. In screen 1206, the user notes that the “Availability” field is empty (there is no asterisk) and chooses to add the availability information by pressing 2. In screen 1208, the user inputs the availability information, and presses “enter.” In screen 1210, the system again presents user with fields that can be edited in the Brickhouse item, but the user presses “done” to indicate completion of the task. In screen 1212, the system shows the user the item information, and provides the ability to submit the modifications to the public directory by pressing 1, or save the information in the user's private directory by pressing 2. The user presses 1. This initiates the Modification Program 330, which determines that the submission limit condition is satisfied. The Modification Program then adds the availability information to the Brickhouse item and associates this user with the availability value in the Brickhouse item.

The Modification Program confirms in screen 1214 that the system modified the Brickhouse item in the public directory. Screen 1214 gives the user the option to subscribe to receive notification when another user changes the Brickhouse item, or unsubscribe from such notification. The user subscribes, and the system then displays screen 1216, the Brickhouse operation list.

FIG. 7 illustrates the logic associated with the interaction sequence. The user elects to edit an entry at 712. Processes 714 and 716 correspond to the user picking “done” or picking a field to edit. The section on inserting a new item has described the input sequence in FIG. 7 (processes 716, 718, 720, 722, 724, 726, 728 and 730). When choosing “done” in decision 714 the Modification Program 330 checks in decision 732 whether any non-null fields were replaced. If all the changed fields were empty, the operation is considered a modification, the user submission reputation is checked in decision 738, and the update is performed in process 742.

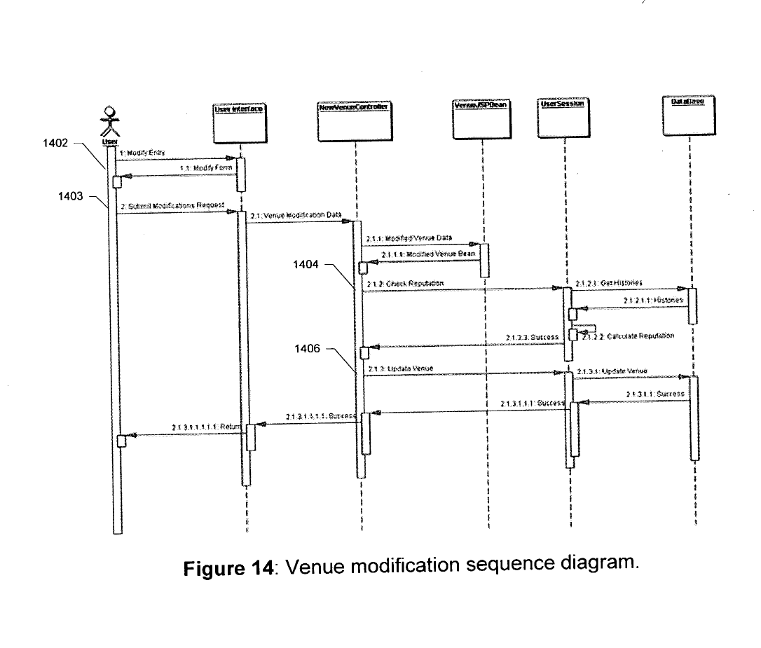

The internal process associated with item modification is depicted as a sequence diagram in FIG. 14. The user fills in information about the modified venue or event in operation 1402. Message 1403 transmits the modifications to the Runtime Controller 308 and the Modification Program 330, where they are converted into objects. Message 1404 directs the UserSession to compute the user's submission limit condition, which results in success. Message 1406 directs the UserSession to perform the update, during which the user's history information is updated.

G. Item Correction

Item correction is the mechanism that allows changing item information when an author misspelled an entry, such as a name, provided incorrect or outdated availability information, or provided an incorrect set of categories. In such cases, allowing a credible author to fix public item information will likely improve the quality of the directory.

During the correction of a public item, the system must determine whether to accept the change. The present invention makes a determination based on either the reputation of the user making the correction, the reputation of the author of the information being corrected, or both.

Since reputation is so important to the quality of the community directory, we must also be concerned with whether an author entered incorrect information or whether the information became outdated. If public item information was incorrect when entered, the system should punish the author of the incorrect information by affecting the author's reputation. If the information grew out of date, the system should not affect the reputation of the author of the incorrect information.

To accomplish this, public item information can be saved with a change date so that, after a predefined period of time from the change date (a “maturation time”), corrections made are assumed to be modifications and do not affect the previous author's reputation. Maturation time values can be associated with an individual entry, a category or the entire directory.

The correction mechanism (324 in FIG. 3) works in consort with the reputation mechanism (318 in FIG. 3) to both correct the entries made by a user and to weigh future directory submissions made by that corrected user.

In some embodiments, when the address or geographic location are changed significantly in a public item, it may be impossible to determine that the change was incorrect (say, for example, someone changes the address of 8^{th} Street San Francisco McDonalds to Borneo—who would see the bad Borneo entry in order to change it back?).

In this embodiment, the Item Deletion mechanism provides for confirmation of a public item deletion by other users. To overcome difficulties when someone changes the location of an item, this embodiment forces users changing the address or geographic location to delete the incorrect item as a whole and re-inserting the item with the new location, rather than through this Item Correction mechanism described here.

This is a location-specific case of a more general problem: When a user changes a field commonly used in searches, there should be a mechanism by which the change is confirmed by later users. The deletion and re-insertion requirement of this embodiment is not a requirement of the invention, but instead could be performed as a modification with the old values remaining for the purposes of search and later user confirmation.

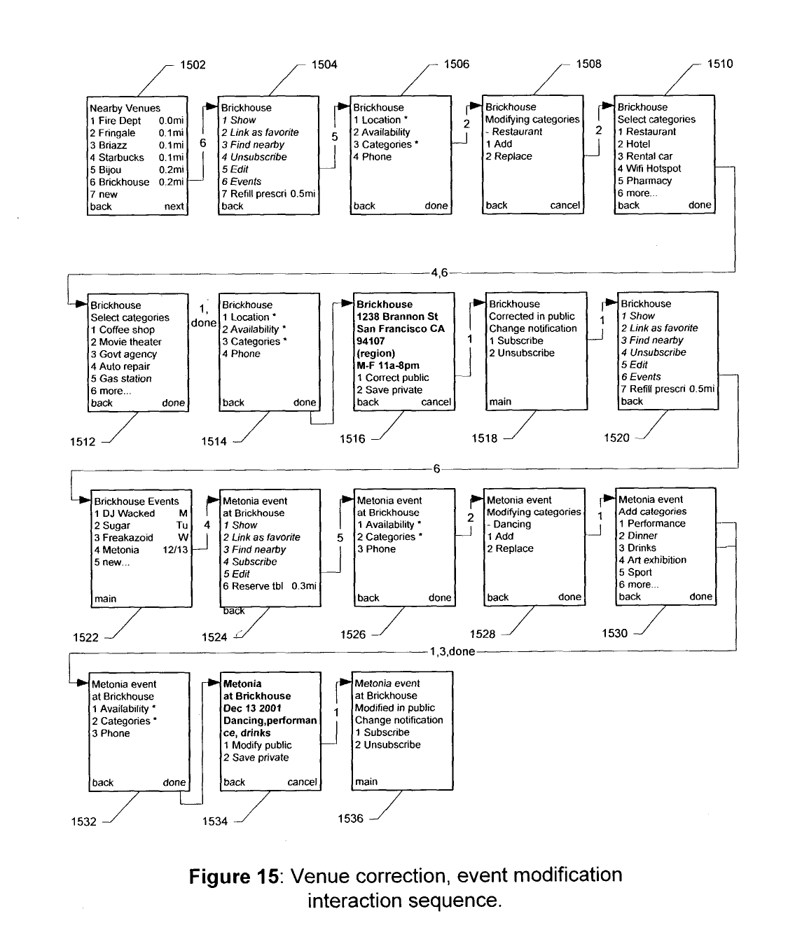

FIG. 15 shows an example of venue correction and event modification. Specifically note that the user replaced the set of categories for Brickhouse in screen 1508, 1510 and 1512. As a result, screen 1516 offers the “Correct public” options, rather than the “Modify public” option shown in the event modification screen 1534. FIG. 7 shows the corresponding flow chart. In this embodiment, the entry point for item correction is the same as for item modification. The difference is that correction takes place when an item field already has a value, and the limit condition used is the “correction limit condition” rather than the submission limit condition. The Correction Program 324 uses the same sequence diagram as the Modification Program 330, except for the limit condition.

A user can correct the user's private items at any time, with no changes to reputation.

H. Item Deletion

As information becomes outdated, businesses move, land changes hands, etc., items in a directory become obsolete and should be removed. This embodiment does not offer an automatic mechanism to keep the directory up to date, but a user may notice, when looking at local venues, that a venue displayed on the mobile terminal is no longer physically there, or that an event no longer occurs on Wednesdays. At that point, the user can select the item and delete it from the directory, assuming that the user's correction reputation is sufficient. When a user deletes an item, the system does not remove it from the directory immediately, but presents it with a different appearance in the user interface (such as “graying it out”). If another user selects a deleted entry in the interface, the user is asked if the venue is actually still there. If the user answers affirmatively, the deleted item is re-introduced into the directory. This process adversely affects the reputation of the user who deleted the entry. After a waiting period in which the entry doesn't get marked for deletion or reinclusion, the entry is marked unavailable in the directory and no longer shows up on the interface.

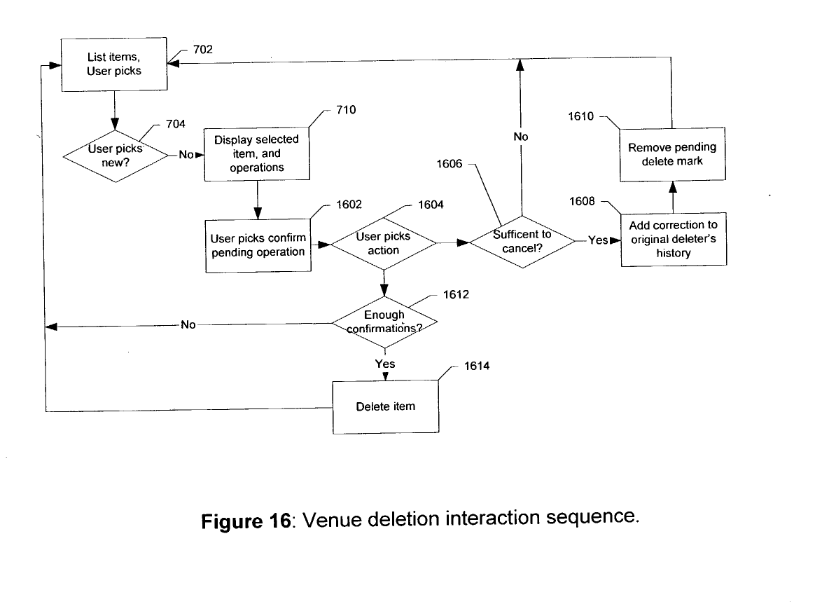

FIG. 16 shows a flowchart for an embodiment of public item deletion. Note that processes 702, 704 and 710 in FIG. 16 are the same as those in FIG. 7.

A user can delete his private items at any time. This results in no changes to reputation.

I. Reputation

User reputation is a mechanism that enables a measure of confidence to be associated with the insertion/modification of new item information, or correction of existing item information in a community directory. A reputation mechanism is desirable due to the contributory nature of the directory. This embodiment does not provide for screening users beforehand for their knowledge or motivations for contributing, therefore a self-regulating quality control system, such as the reputation mechanism, must be present. The reputation mechanism accumulates information about the submission, correction and reference history of information authored by each user, and uses that information to determine whether the system should accept new submissions, corrections or deletions from that user.

Users who contribute highly used information and who receive few corrections against their information gain greater ability to insert new information and correct information. Users who contribute lots of incorrect information, whether by virtue of sloppiness or malice, or whose uncorrected information others rarely reference will have a greater likelihood that the system turns their contributions into private items or even rejected outright.

This embodiment provides for two types of reputation mechanism: submission reputation and correction reputation. They are distinguished from each other because submissions (insertions and modifications) are associated only with a single user who adds information to an item, affecting no other user's reputation, while corrections are associated with multiple users: here, the user changes information that other authors have already entered, affecting their reputations. These two mechanisms differ most significantly by the maximum error rate threshold to perform operations on the directory—corrections are considered more serious, since they affect the reputations of others, and therefore this embodiment provides for a lower maximum error rate threshold for corrections.

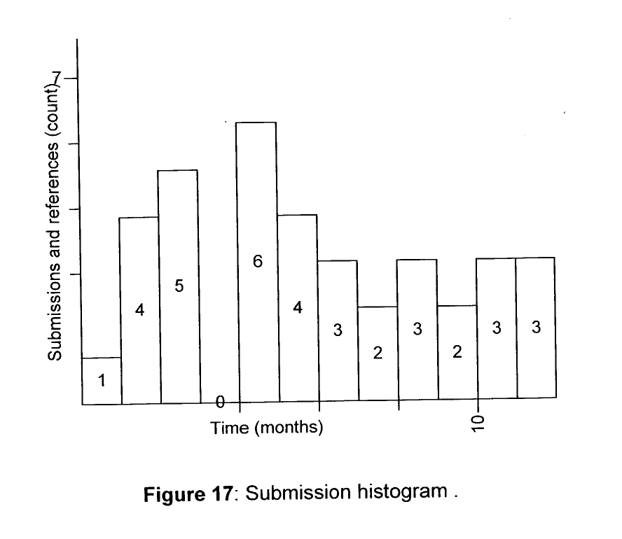

This embodiment defines a user's submission reputation as a ratio of corrections to submissions and references made to items authored by that user during a particular period of time, as shown in FIGS. 17-20. FIG. 17 shows the submission and reference count for an author over a 12-month period, where a submission refers to a single instance of the author inserting or modifying an item (Submissions 411 in FIG. 4), and a reference refers to another user linking to the author's information in a public item (References 414 in FIG. 4). Note that this embodiment is combining a measure of quantity (number of submissions) and value to others (references),

Shown in FIG. 17 is a “blackout period” in the fourth month when an author's submission reputation dropped below the submission reputation threshold. The author was unable to insert or modify item information that month, and no other user linked to the author's data, so the fourth month submissions-plus-references value was zero.

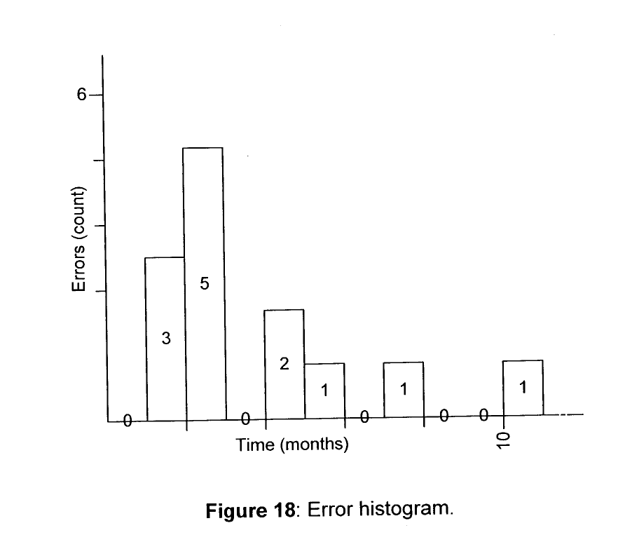

FIG. 18 illustrates the number of errors (i.e., the number of submissions during a particular month that were later corrected) over the same 12-month period. It shows that when the system allowed no submissions, errors didn't occur (and will not occur because errors are assigned to the month of authorship, not the month of correction). There were also no errors reported in months 1, 7, 9, 10, and 12.

In order to avoid punishing heavy contributors who make early mistakes, the error-rate threshold varies with the age of the submission and a decay function applied to older errors. Formula (1) shows an example function to generate the submission error rate, Eᵢ, for an author at month i,

$${E}_{i} = \frac{{\sum }_{k = 0}^{i} d ( k ) {c}_{k}}{max ( 1 , {\sum }_{k = 0}^{i} {s}_{k} + {r}_{k} )} , \qquad ( 1 )$$

where i=0 is the current month, i=1 is the preceding month, etc., where cᵢ is the number of corrections that have been made against the information the author submitted in month i, where sᵢ is the number of submissions the author made in month i, where rᵢ is the number of current references to information the author submitted in month i, and where d(k) is a decay function d(k)=(0.9)^{k}.

From FIG. 17 we have s=[1, 4, 5, 0, 6, 4, 3, 2, 3, 2, 3, 3], and from FIG. 18 we have c=[0, 3, 5, 0, 2, 1, 0, 1, 0, 0, 1, 0]. Suppose r=[0, 1, 2, 0, 0, 2, 0, 3, 0, 4, 1, 0]. To calculate the submission error rate for month 2, Formula 1 expands as follows:

$$\begin{matrix}{E}_{2} = \frac{{c}_{0} + ( 0.9 ) {c}_{1} + ( 0.81 ) {c}_{2}}{{s}_{0} + {r}_{0} + {s}_{1} + {r}_{1} + {s}_{2} + {r}_{2}} \\ = \frac{0 + ( 0.9 ) 3 + ( 0.81 ) 5}{1 + 0 + 4 + 1 + 5 + 2} \\ = \frac{6.75}{13} \\ ≅ 51.9 \%\end{matrix}$$

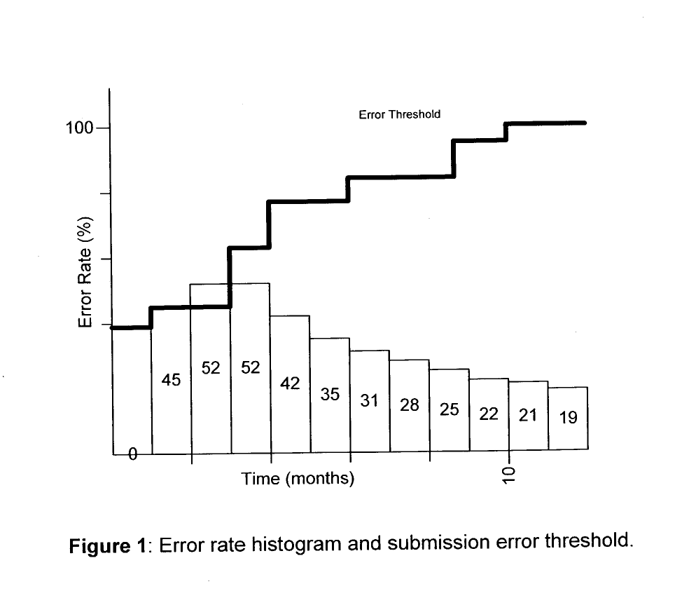

FIG. 1 illustrates the submission error rate Eᵢ as a monthly histogram. Overlaid on top of this histogram is a submission error threshold line. If any month's submission error rate exceeds the submission error threshold line, the system prevents the user from submitting new information.

One embodiment doesn't count as a “correction” changes made by the same author.

Another embodiment allows an author to correct information the author previously submitted, even if submission is otherwise disallowed, providing an opportunity for the author to correct past mistakes before others discover the errors.

FIG. 1 shows the user exceeded the submission threshold of 45% for information authored in month 2, when the submission error rate E₃ has value 51.9. If other users make no additional references to information the user authored, the system will not allow the user to make further submissions during this month. Next month, the histogram shifts one month to the right. If other users make no additional corrections to information the user authored, the system will allow the user to resume making submission.

This embodiment illustrates several aspects of using a reputation mechanism to determine whether to allow an author to change an item directory: First, as the number of corrections made to an author's information increases, the author is be less likely to be able to enter new public information into the community directory. Second, as the number of references to an author's information increases, the author is more likely to be able to enter new public information into the community directory. Third, as the number of submissions increases by an author, the system rewards the author by allowing additional submissions. Finally, if an author's error rate exceeds the threshold, there is a way to limit the punishment (disallowing public submissions) to a period of time—in this embodiment both the decay function and a gradually-increasing error threshold serve to limit the punishment.

Other embodiments could use different time periods, different ways of measuring contributions, utility and errors, and differences in introducing decay or establishing thresholds. Some embodiments could allow a corrector to register an opinion on whether the information was inaccurate through no fault of the author's (such as information going out of date) or whether the author maliciously or erroneously entered the information, providing for greater punishment in the latter case.

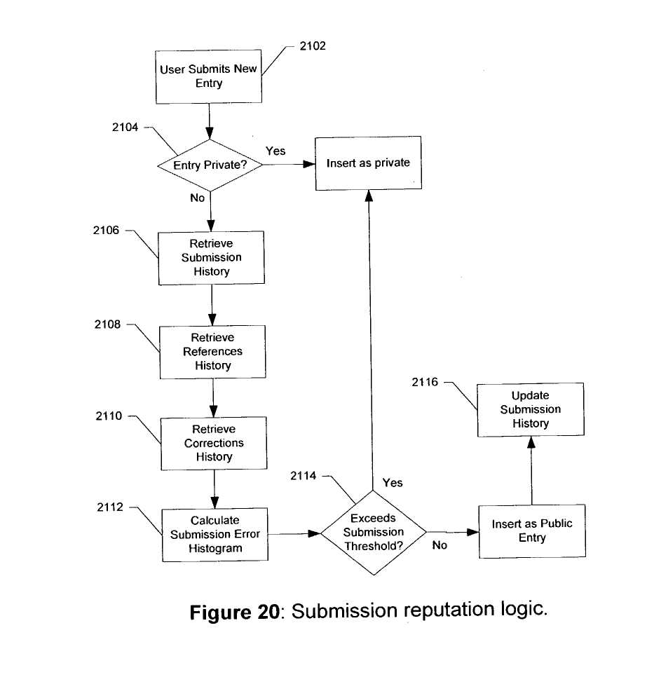

FIG. 20 depicts the reputation mechanism in submission of item information to a community directory. The logic for calculating correction reputation is the same except that there is no consideration of privacy and the correction threshold is different than the submission threshold.

In this embodiment, the system does not calculate a “reputation value”, where a higher number would indicate greater likelihood of an author's submission or correction being accepted. Instead the reputation mechanism uses error rates and thresholds to limit submissions. Other embodiments could calculate a reputation value, and use that in place of the error-rate mechanism described here.

The system associates reputation information with each user and saves that information in the community directory. This embodiment maintains reputation in the form of history information, namely submissions 411, references 414, and corrections 415 in FIG. 4. The reputation mechanism retrieves these history entities (2106, 2108, and 2110), uses them to calculate an error rate histogram (2112) and determine whether a user can submit entries according to Formula 1.

III. Community Location Directory Implementation

An operating environment that can host this embodiment uses Java® J2EE, a programming system and application server framework specification available from Sun Microsystems, Inc., Palo Alto, Calif. (and implemented by several companies, including Sun, IBM, BEA, Macromedia and others) to implement location programs (302 in FIG. 3), WML, which is a wireless markup language used to implement WAP (wireless application protocol)-based user interfaces on wireless devices, Weblogic®, which is an application server conforming to J2EE specifications and commercially available from BEA Systems, Inc., San Jose, Calif., to implement the runtime controller (item 314 in FIG. 3), and Oracle9i®, which is database server software commercially available from Oracle Corporation, Redwood Shores, Calif. to implement the backend (item 304 in FIG. 3). It will appreciated by those skilled in the art that implementations employing the current invention need not be made using Java, J2EE, WAP, or Oracle, and that other mechanisms could be employed.

What is claimed:

1. A method of maintaining a directory of items for a community that includes identified sources, comprising:
a. computing a first limit condition, which is a function a first source's history information,
b. responsive to the first limit condition being true, performing a first operation that includes
inserting the first item value into an item directory, and
associating the first item value with the first source,
c. performing a second operation that includes
updating the first source's history information,
inserting a second item value into the item directory and
associating the second item value with the id of the second source in the item directory,
d. computing a second limit condition, which is a function of the updated first source's history information,
e. responsive to the second limit condition being false,
rejecting a third operation initiated in association with the first source,
whereby inserting item information responsive to a limit condition results in accumulating high quality item information, automatically assessing value of the information acquired from sources, which may be individual users, and
limiting the effects of sources whose item values indicate low quality.

2. The method of claim 1,
a. wherein the second operation further includes
removing the association of the first source with the first item value and
removing the first item value from the directory,
whereby corrections can be made without retaining historical item values.

3. The method of claim 1,
a. wherein updating the history information in the second operation includes updating correction information, and
b. wherein the limit condition is affected by the corrections applied to the first source's insertions,
whereby the system rejects item insertions from sources who have received frequent or pervasive corrections.

4. The method of claim 1,
a. wherein the limit condition is partly affected by the number of uncorrected item values in the directory associated with the first source,
whereby more prolific authors are not punished by correspondingly increased corrections,

5. The method of claim 1, further comprising
a. identifying a third source,
b. prior to the performance of the second operation, creating a private link associated with the third source to the first item value and updating the first history information to reflect that link
c. responsive to the second limit condition being true, performing a third operation initiated in association with the first source,
whereby the history limit condition can allow more insertions by a source who inserts authored item values that are frequently linked,
whereby sources are encouraged to insert values to which users frequently link.

6. The method of claim 1,
a. further compensating a source based on history information associated with the source,
whereby users contributing valuable item values are appropriately rewarded.

7. The method of claim 1,
a. further identifying a third source,
b. further retrieving the first item value on behalf of the third source, prior to the performance of the second operation,
c. responsive to the second limit condition being true, performing a third operation initiated in association with the first source,
whereby the history limit condition can allow more insertions by a user who inserts item values that are retrieved frequently,
whereby authors are encouraged to insert values that users frequently reference.

8. The method of claim 1,
a. wherein item values contain a geographic position,
whereby the directory can store information about locations,
whereby community members can store and retrieve information about geographic resources, such as stores, facilities, bouys, outdoor events, fishing spots, wireless LAN hot-spots, etc.

9. The method of claim 8,
a. further retrieving the geographic position from an automatic geographic positioning device,
whereby users need not manually enter the location.

10. The method of claim 8,
a. further retrieving item values in order of their proximity to a first geographic position,
whereby a user can find the closest geographic resource in the directory.

11. The method of claim 8,
a. wherein item values contain aspects of entities selected from the group of venues and events.
whereby a user can find venues or events in the directory.

12. The method of claim 8
a. wherein item values contain information regarding availability periods,
whereby a user can find venues or events that are available when convenient for the user.

13. The method of claim 1,
a. wherein item values contain a set of categories,
b. further retrieving an item using a search criteria that includes a category,
whereby users can find items appropriate for their needs,

14. The method of claim 1,
a. further storing the current date and time with the first item value,
b. wherein the second limit condition is sensitive to the elapsed time from inserting the first item value into the directory until inserting the second item value,
whereby a user is not overly punished when information goes out of date.

15. The method of claim 1,
a. wherein the second limit condition is sensitive to the number of links or retrievals made to the first item value prior to inserting the second item value,
whereby a user is not overly punished when useful information becomes not useful over time.

16. The method of claim 1,
a. wherein the second operation further includes marking additional item values associated with the first source as invalid,
whereby indications of a poor quality author can result in the author's past contributions being removed from the directory.

17. The method of claim 1,
a. wherein the second limit condition is sensitive to whether the second operation is considered a modification or a correction,
whereby that an item value is incomplete rather than invalid, therefore requiring modification rather than correction, has a different effect on future limitations on the author of the item value.

18. The method of claim 1,
a. wherein obtaining the first item value is replaced by obtaining a series of item values
b. further marking item values as private to a source until a sufficient amount of information is contained in the item values,
c. marking item values as public after a sufficient amount amount of information is contained,
whereby a source can provide partial data in an environment of unpredictable connectivity to a central database

19. A system for adding information to a directory of items, comprising:
a. a memory for storing item values including an item index and an additional value, source values including a source id and history values, and owner associations of source ids and item values,
b. an input controller for receiving source ids and item values,
c. a function evaluator for computing a limit function on a source id dependent on the history values for the source corresponding to the source id,
d. an insertion controller for
i. receiving a first source id and a first item value,
ii. computing the limit function on the first source id, and
iii. if the limit function returns false, stopping the insertion, otherwise
iv. conditional on the memory containing a second item value with the same item index as in the first item value, and the memory containing a first association between a second source id and the item index, update a history value associated with the second source id,
v. irrespective of the condition, store the first item value into the memory, and
vi. irrespective of the condition, stores a second association between the first source id and the first item value,
whereby information on past modifications or corrections made by other sources can be accumulated for a first source, which might be a user, allowing the system to limit future insertions from the first source if the limit function determined that the source historically provided low quality information,

20. The system of claim 19,
a. wherein conditional on the memory containing a second item value with the same item index as in the first item value, and the memory containing a first association between a second source id and the item index, the insertion controller removes the first association,
whereby corrections can be made without retaining historical item values.

21. The system of claim 19,
a. wherein the history values contain correction information, and
b. wherein the limit function is affected by the corrections applied to the first source's insertions,
whereby the system rejects item insertions from sources who have received frequent or pervasive corrections.

22. The system of claim 19,
a. wherein the limit condition is partly affected by the number of uncorrected item values in the directory associated with the first source,
whereby more prolific authors are not punished by correspondingly increased corrections,

23. The system of claim 19,
a. wherein the limit function is affected by the links applied to the first source's insertions,
b. a link controller which creates a private link associated with the third source to the first item value and updates the first history values to reflect that link
whereby the limit function can allow more insertions by a source who inserts authored item values that are frequently linked,
whereby sources are encouraged to insert values to which users frequently link.

24. The system of claim 19,
a. further compensating a source based on history information associated with the source,
whereby users contributing valuable item values are appropriately rewarded.

25. The system of claim 19,
a. wherein the limit function for a source is affected by retrievals of the item values associated with the source,
b. further comprising a retrieval controller which receives a third source id and a third item index, identifies a fourth source id associated with the third item index, retrieves a third item value associated with the third item index, on behalf of the source, and updates the history values associated with the fourth source id,
whereby the limit function can allow more insertions by a user who inserts item values that are retrieved frequently,
whereby authors are encouraged to insert values that users frequently retrieve.

26. The system of claim 19,
a. wherein item values contain a geographic position,
whereby the directory can store information about locations,
whereby community members can store and retrieve information about geographic resources, such as stores, facilities, bouys, outdoor events, fishing spots, wireless LAN hot-spots, etc.

27. The system of claim 26,
a. wherein the input controller can request the geographic position from an automatic geographic positioning device, without requiring receiving the geographic position through its interface,
whereby users need not manually enter the location.

28. The system of claim 26, further comprising
a. a search controller that receives a geographic position and retrieves a set of item values, returning them in order of their proximity to a first geographic position,
whereby a user can find the closest geographic resource in the directory.

29. The system of claim 26,
a. wherein item values contain aspects of entities selected from the group of venues and events.
whereby a user can find venues or events in the directory.

30. The system of claim 26
a. wherein item values contain information regarding availability periods,
whereby a user can find venues or events that are available when convenient for the user.

31. The system of claim 19,
a. wherein item values contain a set of categories,
b. further comprising a retrieval controller which receives a search criteria that includes a category and returns a set of item values satisfying the search criteria,
whereby users can find items appropriate for their needs,

32. The system of claim 19,
a. wherein the insertion controller stores the current date and time with the first item value,
b. wherein the limit function is sensitive to the elapsed time from inserting an item value into the directory until a second item value supercedes or enhances it,
whereby a user is not overly punished when information goes out of date.

33. The system of claim 19,
a. wherein the limit function is sensitive to the number of links or retrievals made to an item value prior to insertion of a second item value that supercedes or enhances it,
whereby a user is not overly punished when useful information becomes not useful over time.

34. The system of claim 19,
a. wherein the insertion controller further marks other item values associated with the first source as invalid,
whereby indications of a poor quality author can result in the author's past contributions being removed from the directory.

35. The system of claim 19,
a. wherein the limit function is differently sensitive to history values indicating a modification or a correction,
whereby that an item value is incomplete rather than invalid, therefore requiring modification rather than correction, has a different effect on future limitations on the author of the item value.

36. A geographical input method allowing a user to specify a specific location comprising:
a. obtaining an approximate geographic location,
b. presenting a geographic representation,
c. receiving user input to select a point on the geographic representation,
d. computing the geographic location of the selected point by interpolating from known points on the geographic representation,
whereby a user can compensate for inaccuracies in the approximate location.

37. The method of claim 36, further comprising
a. receiving natural language navigation instructions from the user,
whereby a user can supplement a specific location with instructions on how to enter a building, contact a security guard, find an item, determine the floor and suite of an office, etc.

38. A geographical input method allowing a user to specify geographic region comprising
e. determining an approximate geographic location,
f. presenting a geographic representation,
g. allowing the user to manipulate a pointing device to outline a region on the geographic representation,
h. computing the geographic location of the selected region by interpolating from known points on the geographic representation,
whereby a user can both compensate for inaccuracies in the approximate location and identify a region in the geographic representation, such as a map or satellite photograph, representing a building or area where the user can be found.

39. The method of claim 38, further comprising
a. receiving natural language instructions from the user,
whereby a user can supplement a specific location with instructions on how to enter a building, contact a security guard, find an item, determine the floor and suite of an office, etc.

40. A geographic input triggering method allowing a system to prompt input of location information comprising
a. determining the location of a device at a first time,
b. determining the location of the device at a second time,
c. computing a first condition on the device location being approximately in the same location at the first time and the second time,
d. responsive to the first condition being true, inserting the location into a directory,
whereby a device remaining stationary in a location likely indicates some importance that should be recorded.

41. The method of claim 40,
a. wherein responsive to the first condition being true,
i. prompting a user to input information about the location and
ii. inserting the information into a directory.
whereby a user can create more complete item information about the location.

42. The method of claim 41, further comprising
a. computing a second condition testing whether the location is not already in the directory,
b. wherein responsive to both the first condition and second condition being true,
i. prompting a user to input information about the location and
ii. inserting the information into a directory.
whereby the system does not unnecessarily bother a user if information is already in the directory.

43. The method of claim 40, further comprising
a. computing a second condition succeeding if either the location is not already in the directory, or if information associated with the location in the directory was not inserted within a specified time period,
whereby the system can verify information that hasn't been inserted or verified in the recent past.

44. A system for inputing a specific geographic location comprising
a. a memory storing geographic representations indexed by geographic location,
b. a display device that can show a geographic representation and a pointer,
c. an input pointer,
d. an input button,
e. a display translator that converts a geographic location to a geographic representation and a display position on the display device when it is displaying the representation,
f. an input translator that converts the position of the input pointer and a geographic representation to a geographic location,
g. an input controller which
i. receives a first geographic location,
ii. performs display translation to obtain a first geographic representation and a first display position,
iii. displays the geographic representation on a display device,
iv. waits for an input button to indicate it has been clicked,
v. determines the input pointer position,
vi. performs input translation on the input pointer position to obtain a second geographic location, and
vii. returns the second geographic location,
whereby a system can present an approximate location on a map or photograph to a user and receive a corrected location back.

45. The system of claim 44,
a. further comprising a natural language input device,
b. wherein the input controller further receives natural language from the natural language input device and returns it with the second geographic location,
whereby a user can supplement a specific location with instructions on how to enter a building, contact a security guard, find an item, determine the floor and suite of an office, etc.

46. A system for inputing a specific geographic location comprising
a. an image memory storing geographic representations indexed by geographic location,
b. a region memory storing a sequence of geographic locations,
c. a display device that can show a geographic representation and a pointer,
d. an input pointer,
e. an input button,
f. a completion indicator,
g. a display translator that converts a geographic location to a geographic representation and a display position on the display device when it is displaying the representation,
h. an input translator that converts the position of the input pointer and a geographic representation to a geographic location,
i. an input controller which
i. receives a first geographic location,
ii. performs display translation to obtain a first geographic representation and a first display position,
iii. displays the first geographic representation on the display device,
iv. waits for the input button to indicate it has been clicked or the completion indicator to indicate completion,
v. if the completion indicator indicates completion, returns the contents of the region memory and terminates, otherwise
vi. determines the input pointer position
vii. performs input translation on the input pointer position to obtain a new geographic location, and
viii. appends the new geographic location in the region memory,
ix. goes to step iv,
whereby a system can present an approximate location on a map or photograph to a user and receive the outline of a region or a path back.

47. The system of claim 46,
a. further comprising a natural language input device,
b. wherein the input controller further receives natural language from the natural language input device and returns it with the second geographic location,
whereby a user can supplement a specific location with instructions on how to enter a building, contact a security guard, find an item, determine the floor and suite of an office, etc.

48. An input prompting system to collect location information comprising
a. a geographic location memory,
b. a geographic positioning system that returns a geographic location,
c. a trigger controller which
i. requests a first geographic location from the geographic positioning system,
ii. stores the first geographic location in the geographic location memory,
iii. waits for a period of time,
iv. requests a new geographic location from the geographic positioning system,
v. compares the new geographic location to the geographic location memory contents,
vi. if the two locations differ less than a distance limit, returns with the new geographic location, otherwise,
vii. stores the new geographic location in the geographic location memory,
viii. goes to step iii,
d. an input controller which,
i. waits for the trigger controller to return a geographic location,
ii. displays a prompt on an output device,
iii. receives input information,
iv. returns the input information and the geographic location,
whereby a device remaining stationary in a location likely indicates some importance that can be associated with a set of input from a user.

49. The system of claim 48, further comprising
a. a location directory,
b. wherein, the trigger controller returns only if no location in the location directory is within a distance limit of the new geographic location, otherwise continues,
whereby the system does not unnecessarily bother a user if information is already in the directory.

50. The system of claim 48,
a. wherein, the trigger controller returns only if all locations within a distance limit were modified prior to a limit date, otherwise continues,
whereby the system can verify information that hasn't been inserted or verified in the recent past.
